(19) United States
(12) Patent Application Publication
(10) Pub. No.: US 2012/0240036 A1
(43) Pub. Date: Sep. 20, 2012

(54) E-Book Reading Location Indicator

(75) Inventors: Joe R. Howard, San Jose, CA (US); Alan C. Cannistraro, San Francisco, CA (US); Scott A. Grant, Sunnyvale, CA (US); Timothy B. Martin, Morgan Hill, CA (US)

(73) Assignee: APPLE INC., Cupertino, CA (US)

(21) Appl. No.: 13/050,768

(22) Filed: Mar. 17, 2011

(51) Int. Cl. G06F 17/00

(52) U.S. Cl. 715/251

(57) ABSTRACT

To help a reader of an electronic document, e.g., an eBook, find his or her reading location following a repagination event, an electronic reader application executing on an electronic device displays a first portion of content of the electronic document, detects that the reader has performed a predetermined action that triggers repagination of the electronic document, and repaginating the electronic document to cause the reader application to display a second portion of content of the electronic document, the second portion including at least some of the first portion of content and at least some newly visible content of the electronic document, such that the newly visible content appears visually different, at least temporarily, from the first portion of content that remains visible.

### BACKGROUND

This disclosure relates to displaying and facilitating the manipulation of electronic text, for example, the text of an electronic book (“eBook”) being read on an electronic device.

Much like an ordinary printed book, electronic books (“eBooks”), or more generally, electronic documents, can be used to present text and pictures to readers. Instead of ink and paper, however, an electronic book is a collection of digital data that software, known as an electronic book reader application, can interpret and present on a display. A variety of devices run electronic book reader software such as desktop and notebook computers, eBook readers, smart phones and/or other mobile devices. One available format for eBooks is defined by the “ePub” standard, which is maintained by The International Digital Publishing Forum (IDPF).

### SUMMARY

Implementations of the subject matter described here may include one or more of a method performed by an electronic device, a system that includes an electronic device having a processor and memory hat holds instructions for execution by the processor, and/or an article bearing machine-readable instructions that when executed by a processor perform specified operations. In any case, such implementations may include one or more of the following features. For example, a reader application executing on the electronic device may display a first portion of content of an electronic document, detect that a user of the reader application has performed a predetermined action that triggers repagination of the electronic document, and repaginate the electronic document to cause the reader application to display a second portion of content of the electronic document. The second portion may include at least some of the first portion of content and at least some newly visible content that appears visually different from the first portion of content that remains visible.

Detecting that the user has performed a predetermined action that triggers repagination may include determining that the user has selected to change a font size, a font style or a font type of the displayed content, and/or that the user has rotated the electronic device from a portrait orientation to a landscape orientation or vice versa.

The reader application may also display the remaining visible first portion of content in a same manner as prior to repagination and displaying the newly visible content in a different manner. Alternatively, the reader application may display the newly visible content in a same manner as the first portion of content appeared prior to repagination and displaying the remaining visible first portion of content in a different manner after repagination. The reader application may also transition appearance of the newly visible content or the remaining visible first content portion, or both, to a state in which the newly visible content and the remaining first content portion appear alike. Repaginating the electronic document may include applying a visual transition effect (e.g., a fade, a wipe, a pop, a transition and/or a float) to the new visible content or the remaining first content portion or both. Alternatively, or in addition, the visual transition effect may include one or more of changing color, changing opacity, applying highlighting, changing font size, changing font style, changing font type, or displaying a pointer.

A translation effect may include moving a block of old text from a first position on a display screen of the electronic device to a second position on the display screen of the electronic device. A float effect may include causing a block of old text to appear to move in a Z-plane from a perspecitive of a user viewing a display screen of the electronic device.

A visual difference between the newly visible content and the remaining visible first content portion may be transitory or may persist until occurrence of a predetermined event (e.g., repagination, receiving input from the user, passage of a predetermined duration of time).

Newly visible content that precedes the first content portion in the electronic document may be displayed in a visually different manner. Alternatively, newly visible content that follows the first content portion in the electronic document may be displayed in a same manner as the remaining visible first content portion.

Details of one or more implementations are set forth in the accompanying drawings and the description below. Other features, aspects and advantages will be apparent from the description and drawings, and from the claims.

### DRAWING DESCRIPTIONS

FIG. 1 illustrates examples of different types of electronic devices that can be configured to access, via a network, items of digital media residing on a computer system controlled by a content provider.

FIGS. 2A, 2B and 2C collectively illustrate an example of a reading location indicator.

FIGS. 3A, 3B and 3C collectively illustrate another example of a reading location indicator.

FIGS. 4A, 4B and 4C collectively illustrate another example of a reading location indicator.

FIG. 5 is a flowchart of an exemplary process for providing a reading location mechanism to a user of an eBook reader application.

FIG. 6 depicts an electronic device that can be used to for eBook applications.

Like reference symbols in the various drawings indicate like elements.

### DETAILED DESCRIPTION

In general, an aspect of the subject matter described here is that an eBook reading application may be implemented to help a reader find the location in the book at which the reader was reading—referred to interchangeably as the “reading location” or the “page location”—when an event occurs that causes the eBook to be repaginated or otherwise change its display such that the words of the eBook change positions on the currently displayed page.

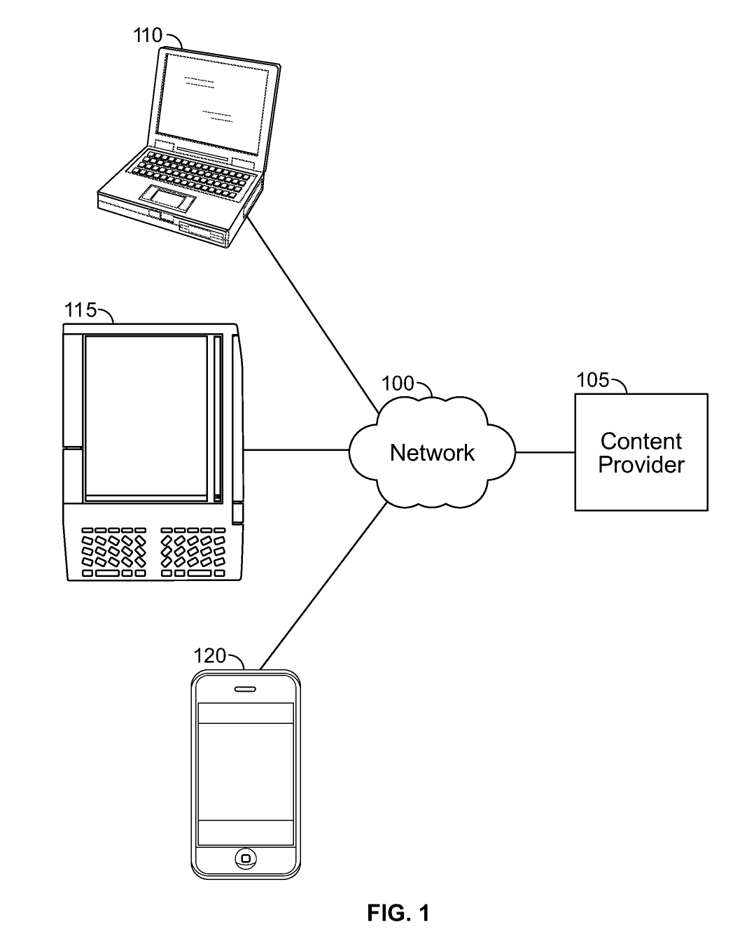

As shown in FIG. 1, any of several different types of electronic devices (e.g., notebook computer 105, a tablet computer or eBook reader 115, smart phone 120) may be configured to access, via a network 100, items of digital media (e.g., eBooks, movies, songs or the like) residing on a computer system controlled by a content provider 105 (e.g., an online web site that sells eBooks and/or other types of digital media). A user of such an electronic device can view, purchase and download eBooks from the content provider 105 and then use an eBook Reader software application residing on the electronic device to read or otherwise peruse the purchased eBook.

Depending on implementation, the eBook reader application may need to repaginate (e.g., changing the set of words displayed in the current view) in response to events such as change of font size, type or style, rotation of the device from portrait to landscape view and the like. For example, if while viewing an open eBook in an eBook reader application, the user changes the font size, the eBook reader in response may automatically repaginate to change the current view to display one or more of the currently displayed words at different locations on the visible page. In addition, as a result of the repagination, some currently visible words may disappear from view altogether and/or new words not previously visible may become visible in the newly displayed view of the eBook. For the purpose of this description, text that was visible before the repagination is referred to as “old text” and text that becomes newly visible as a result of the repagination is referred to as “new text.”

As a more specific example, if the user increases the current font size, the current display will change to display larger characters but, as a result, fewer words will necessarily be visible since the amount of screen real estate is fixed. Conversely, if the user decreases the current font size, the current display will change to display smaller characters and thus more words, including words not previously visible (i.e., new text), will become visible as a result.

Similarly, if the eBook reader application is executing on a rotatable device such as a tablet or a smart phone and the user rotates the mobile device either from portrait to landscape view (typically causing the eBook reader to change from displaying a single page of the eBook to displaying two adjacent pages of the eBook) or from landscape view to portrait view (typically causing the eBook reader to change from displaying two adjacent pages of the eBook to displaying a single page of the eBook), re-pagination occurs in a similar manner to change the display of the viewable text. The resulting view typically (but not necessarily) includes a combination of at least a portion of old text and some new text appearing either before or after, or both, old text.

In any of the above-described scenarios, it is possible, if not likely, that a change in pagination by the eBook reader will cause the word at the user's current reading location to appear at a different location in the display following the change in display resulting from the pagination. As a result, repagination often may cause the reader to lose sight of his or her current reading position. To help the reader to find his or her reading location following such a change, various visual aids have been developed that provide signals to the reader that aid in pinpointing the reader's reading location.

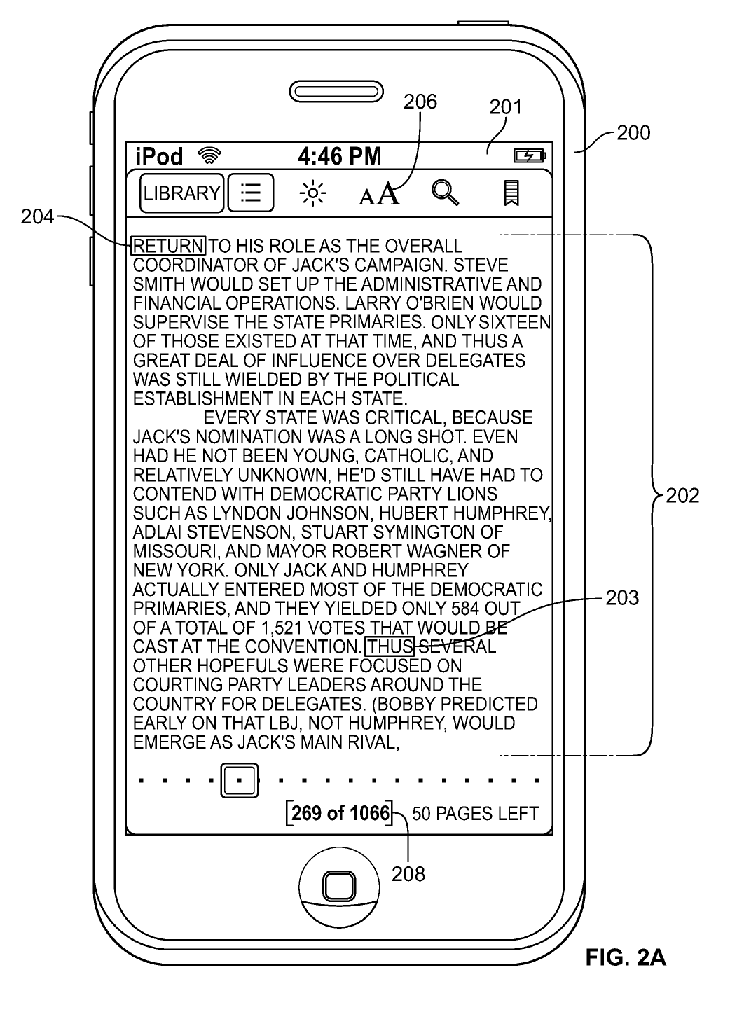

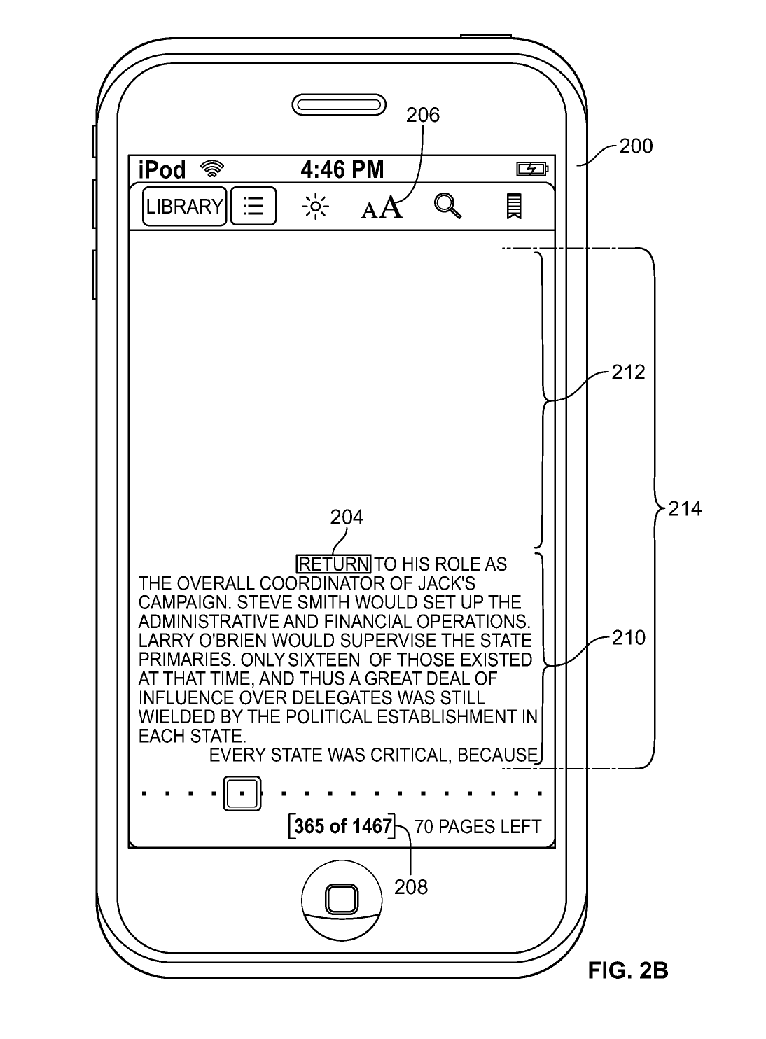

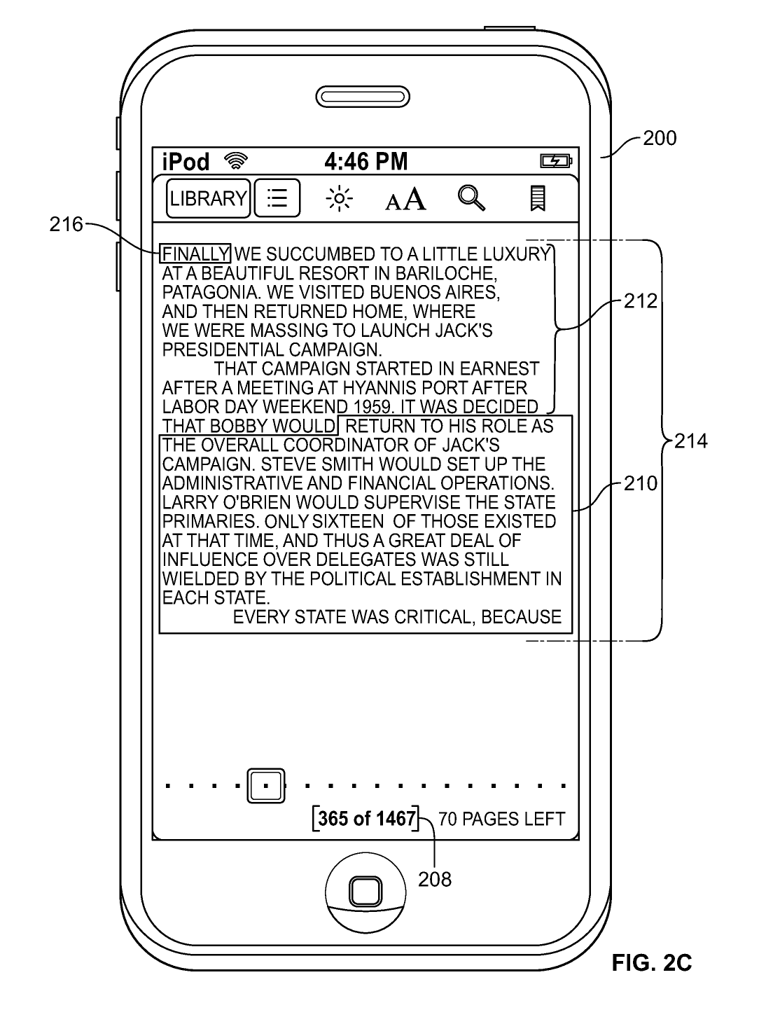

FIGS. 2A, 2B and 2C are snapshots corresponding to before, during and after states in time, respectively, that illustrate one implementation of such a reading location identification aide. Although these figures show the eBook reader application executing on a mobile device 200, the reading location identification aide could just as easily be implemented in an eBook reading application executing on essentially any other hardware platform.

As shown in FIG. 2A, an eBook reader application 201 executing on device 200 displays a page of text 202 formed of multiple words being displayed at a currently selected font size. For purposes of this example, all of the words forming the page of text 202 shown in FIG. 2A can be thought of as old text, meaning that it is the text that is visible before a repagination event. Anchor point 204 corresponds to the upper left corner of the eBook page, which consistent with the English-language reading convention, is considered to be the first word appearing on the page. For books written in other languages that use different reading conventions (e.g., Hebrew), the anchor point 204 would be located at a different position on the screen corresponding to the first word on the page under the reading convention being used.

If, at the state shown in FIG. 2A, a repagination event was triggered, for example, in response to the user interacting with the eBook reader's Font Size Control 206 to enlarge the font size, the reader's display would be updated in response to the repagination to appear, for example, as shown in FIG. 2B, in which the visible page of text 214 includes a portion of old text 210 and a portion of new text (indicated by reference 212 but not yet visible for reasons explained below). As illustrated therein, the repagination event has caused several changes to occur including a change in the current and total page numbers (as shown at Page Number Indicator 208), the displayed font has increased in size, the displayed page now includes a combination of old text 210 and (currently invisible) new text 212, and the anchor point 204, which in the state of FIG. 2A appeared in the upper left hand corner of the eBook page, is now displayed roughly mid-page at a position corresponding to mid-sentence.

The state shown in FIG. 2B is a transitory state, meaning that it appears in this manner only for a specified period of time (e.g., 1 or 2 seconds) and then transitions into a different state such as shown in FIG. 2C. The purpose of this transition is to draw the reader's eye to, or otherwise indicate, the old text 210 in general and the old anchor point 204 in particular. The rationale for making the old text 210 visible, and the new text 212 temporarily invisible, in the transitory state of FIG. 2B is that the user's reading point prior to repagination—for example, the word “Thus” 203 in FIG. 2A—necessarily must have somewhere in the old text 202. By making the new text 212 (which by definition could not contain the user's pre-repagination reading point) invisible, and at least a portion 210 of the old text visible, the reader will be able to more readily discern and pickup at his or her reading point because, generally speaking, the user will have an intuitive sense of how far past the anchor point 204 the user's reading point was prior to repagination.

In this example, as often may be the case in actual usage, the user's reading point 203 in fact is not visible in the repaginated page of text 214 in FIG. 2B but rather resides on the next page in this repaginated format, which is not yet displayed. Nevertheless, because the user will be able to readily discern the pre-repagination anchor point 204 as a result of the transitory effect, the user will be able to quickly gather that his or her reading point is not visible in the repaginated view and that the user must turn to the next page to pick up at the reading point.

FIG. 2C completes this example by illustrating how the eBook reader display may appear after the transitory period has lapsed and the new text 212 has become fully visible to the reader, and the word “Finally” becomes the new anchor point 216. Although the example of FIGS. 2A-2C illustrates an exemplary implementation of a reading location indicator in the context of repagination trigger by a change in font size, essentially the same mechanism can be used in response to any or all repagination events whatever the cause, for example, not only changes to text size but also rotation of the device on which the eBook reader is executing, dynamic insertion of new text or a graphic object, changes in font style or font type, and the like.

Depending on implementation details and design choices, various different transition effects can be used to signal to the user the distinction between old text and new text following repagination. For example, as in the example of FIGS. 2A-2C, the transition effect is known as a “fade” in which the new text 212 is initially represented by a blank space (that is, the new text 212 starts off invisible) that gradually “fades in” (increases in opacity) until it appears essentially the same as the old text 210. Alternatively, a “transparent fade” could be used in which the new text 212 starts off not as invisible but rather as faint (relative to the old text 210) and then gradually increases in opacity until the new text appears the same as the old text 210. The duration and speed of such a transparent fade could be fast or slow or anywhere in between.

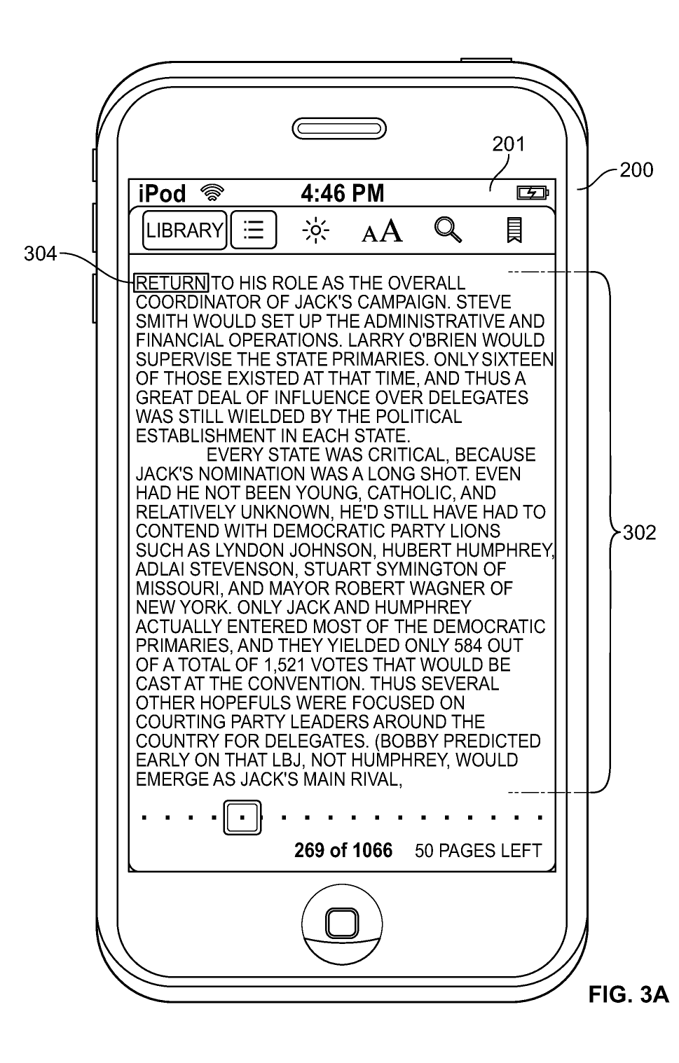

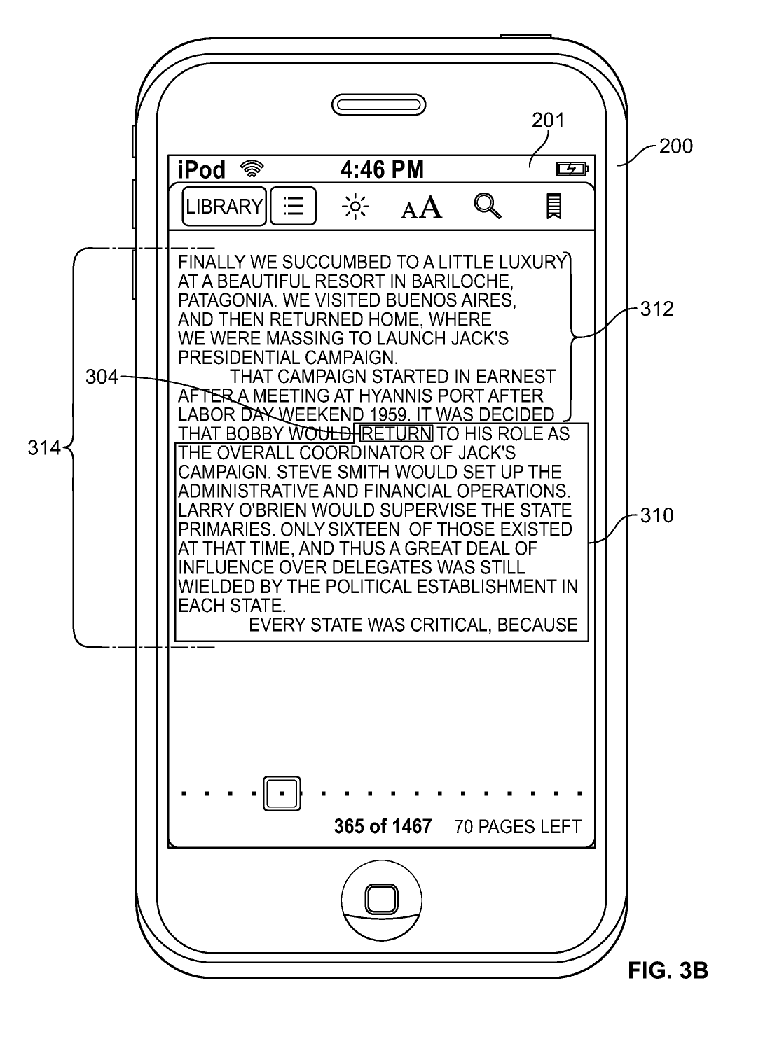

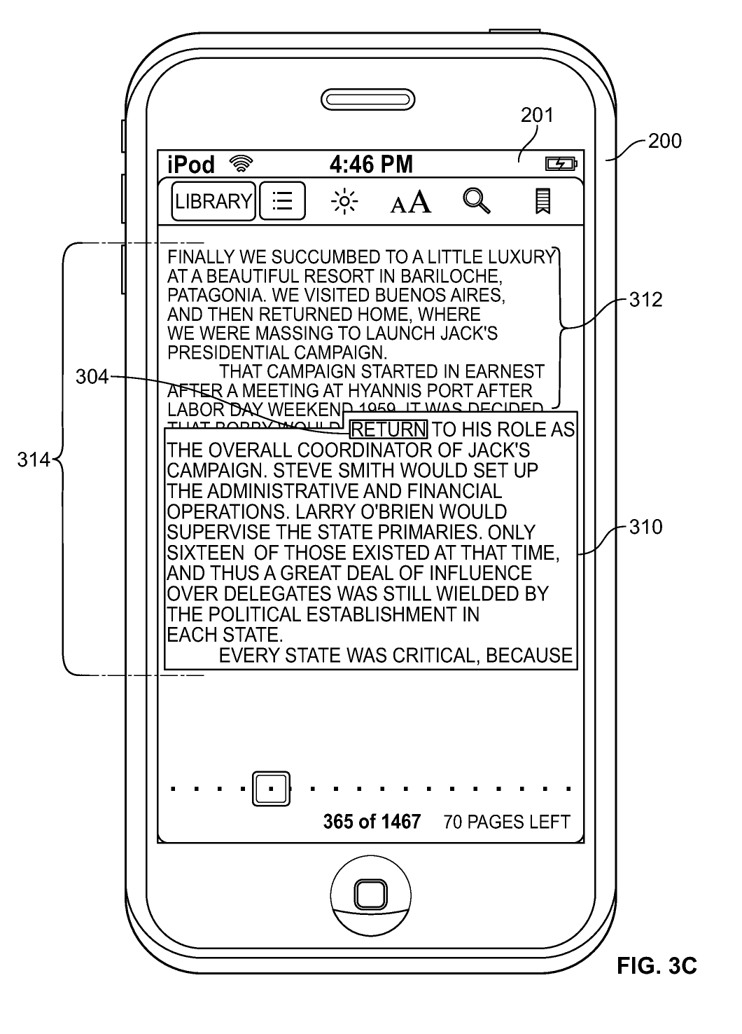

FIGS. 3A-3C show before, during and after states of another type of post-repagination transition effect, namely, a “pop” effect. FIG. 3A shows the before (i.e., pre-repagination) state in which the eBook reader application 201 is displaying a page of text 302, with an anchor point 304 (the word “return”). In response to an increase in font size, the eBook reader display changes as shown in FIG. 3B to display a repaginated page of text 314 that includes a portion of new text 312 and a portion of old text 310. Unlike the change of states in the example of FIGS. 2A-2B, in this example the repaginated page of text 314 is displayed, at least initially, such that the new text 312 appears the same as the old text 310. However, shortly after the state shown in FIG. 3B is displayed (which lasts, e.g., a fraction of a second) the eBook reader causes the block of old text 310 to “pop”—that is, to appear to temporarily “pop out” at the user as if that block of old text 310 were being temporarily magnified.

In this manner, the user is able to differentiate old text from new text, as well as receive a visual clue as to the post-pagination position of anchor point 304, and thus able to use that information to discern and pick up reading at the reading point. Alternatively, instead of having the entire block of old text 310 to pop, a “word pop” transition could be implemented in which only a single word—for example, the anchor word 304—would pop out at the user. Also, instead of having the old text 310 pop, the page location indication transition could be implemented to have the new text 312 pop as the transition effect.

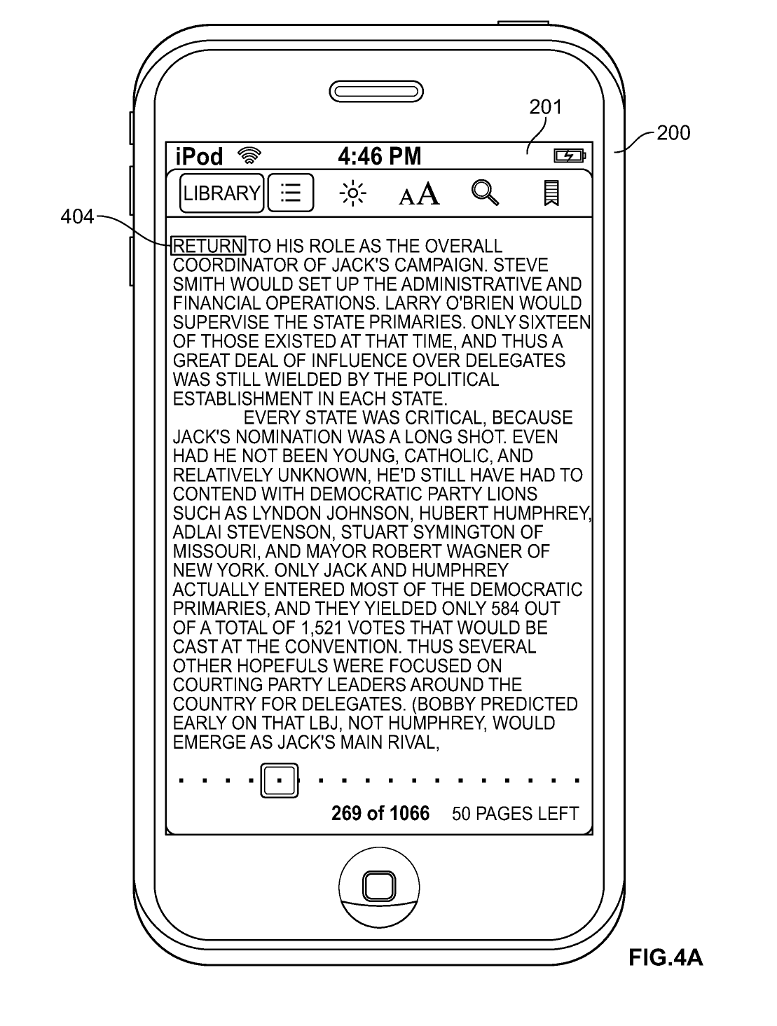

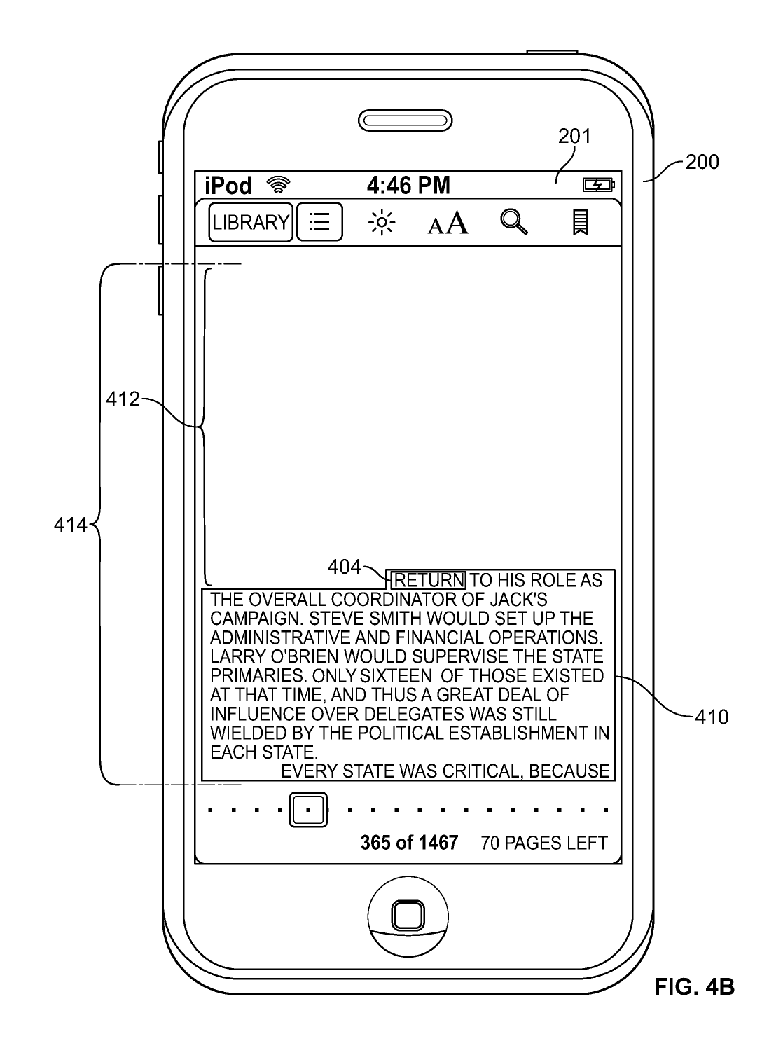

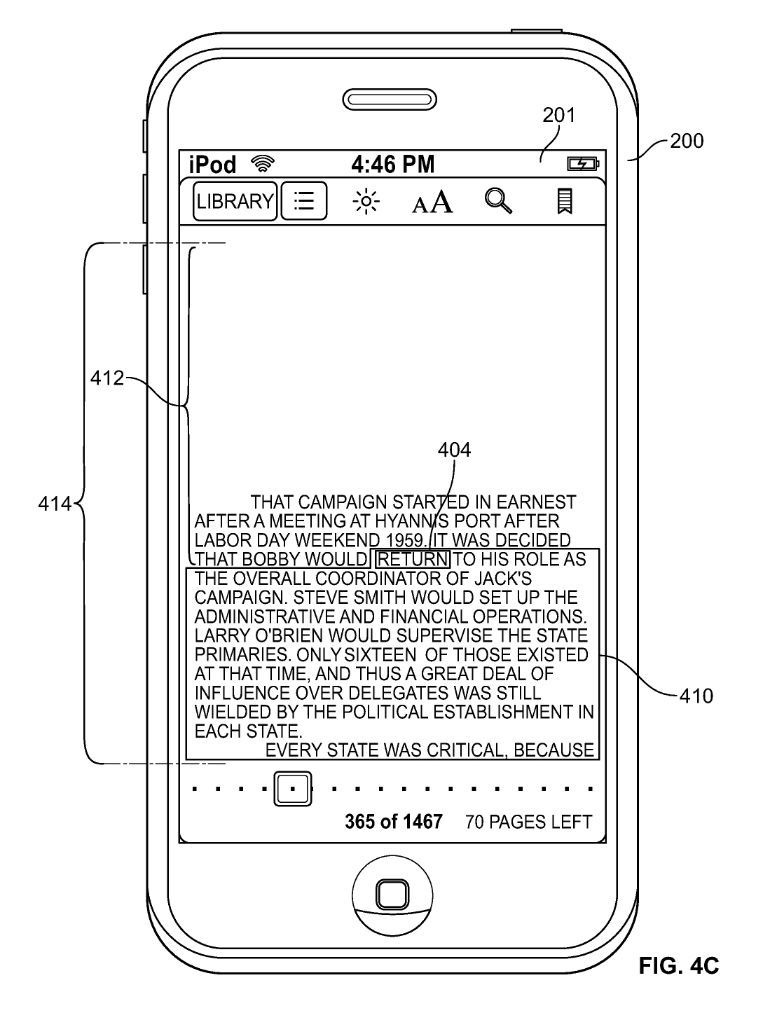

FIGS. 4A-4C illustrate another example of a transition effect that could be implemented by an eBook reader application to provide a reading location indicator. As shown therein, the pre-repagination “before” state shown in FIG. 4A switches to a post-repagination transitory state as shown in FIG. 4B, in which the old text 410 is displayed as normal and the new text 412 is invisible and is represented by blank space. As soon as the state of FIG. 4B is displayed, however, the eBook reader application initiates a “wipe” transition effect in which the new text 412 increases in opacity starting at a position in the display corresponding to the post-repagination location of the anchor point 404 and progress gradually upwards until all of the repaginated text 414 is fully visible to the user.

Other variations of the wipe effect could be implemented, for example, a side-to-side wipe or a wipe that starts at the top of the eBook page and progresses downwards. More generally, any or all of the transition effects described here could be modified or substituted with essentially any desired transition effect that serves to provide a visual clue about which text following repagination is new and which is old, thereby facilitating the user's re-location of his or her reading location. For example, instead of, or in addition to the transition effects described here, visual elements such as color, highlighting, pointers, animations, cursors or the like could be used to help the user relocate the reading location.

Moreover, although in the examples described above the transition effect is applied only to portions of new text that appear prior to the pre-repagination anchor point. Alternatively, similar transition effects could be applied to any new text that comes after the old text and which becomes newly visible as a result of repagination (which, for example, may occur when repagination occurs in response to user input specifying that the font size is to be decreased).

Other transition effects may be used. For example, a translation effect could be used in which at least a portion of the old text that will remain visible following a repagination event could be animated to appear to move as a block from its pre-pagination position on a page to its post-pagination position on the displayed page or pages. A potential implementation of such a translation effect could occur, for example, where a user changes font size, rotates the devices or otherwise triggers a repagination event. In response, a portion of the old text could fade away (because it will no longer be visible post-repagination) while the words forming a remainder of the old text (specifically, that portion that will remain visible post-pagination) move en masse from their original positions to their new positions. Then, for example, the newly displayed text could become visible via a fade in transition, or any of the other above-discussed transitions.

Optionally, as part of the translation effect, the block of words forming the old text that will remain visible post-pagination could be made to appear to float up and away from the page (i.e., appear to move closer to the user in the Z-plane), then float in the X-Y plane to the new post-pagination position, and then float down (i.e., appear to move away from the user in the Z-plane) to become part of the newly repaginated page.

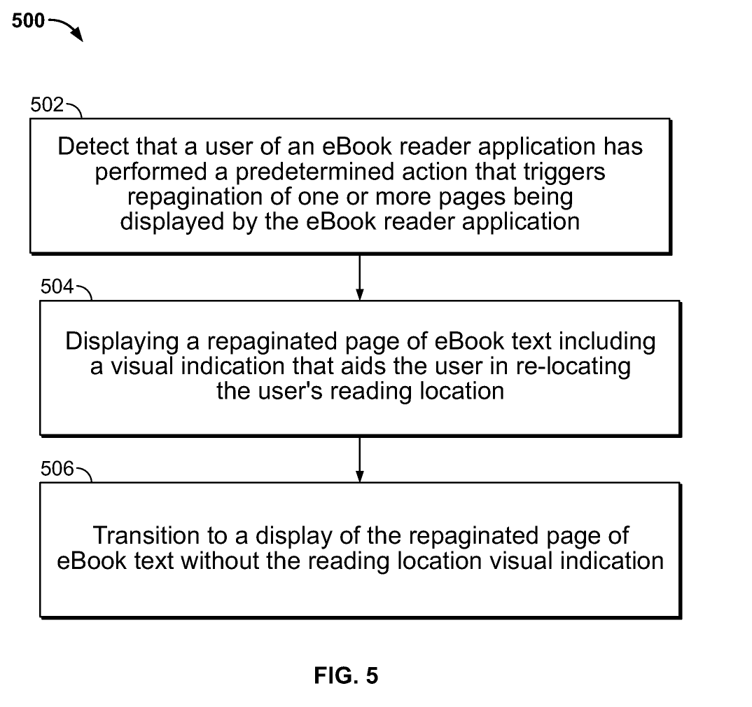

FIG. 5 is a flowchart of a process 500 that may be used by an eBook reader application to provide a reading point location mechanism to a user following repagination. As shown therein, at 502, the eBook reader detects that a user has performed a predetermined action (e.g., change font size, type or style, rotate from portrait view to landscape view or vice versa) that triggers repagination of one or more pages currently being displayed by the eBook reader.

At 504, in response to repagination, the eBook reader displays a repaginated page of eBook text that includes a visual indication that aids the user in relocating the user's reading location. As described above, such a visual indication could include a transition effect such as a fade, a wipe or a pop that helps the user differentiate between old text and new text, and thus gives a visual clue that helps the user pinpoint his or her reading location. Alternatively, or in addition, the visual indication could be another type of indicator such as the use of different colors or including a pointer or cursor in the display that suggests information helpful to finding the reading location.

At 506, after a predetermined duration of time, the eBook reader display changes to display the repaginated page of eBook text but without the visual indication. Depending on design and implementation preferences, removing the visual indication from the display is optional. That is, the visual indication that aids in pinpointing reading location could persist, for example, until the user has turned to another page or triggers another repagination event.

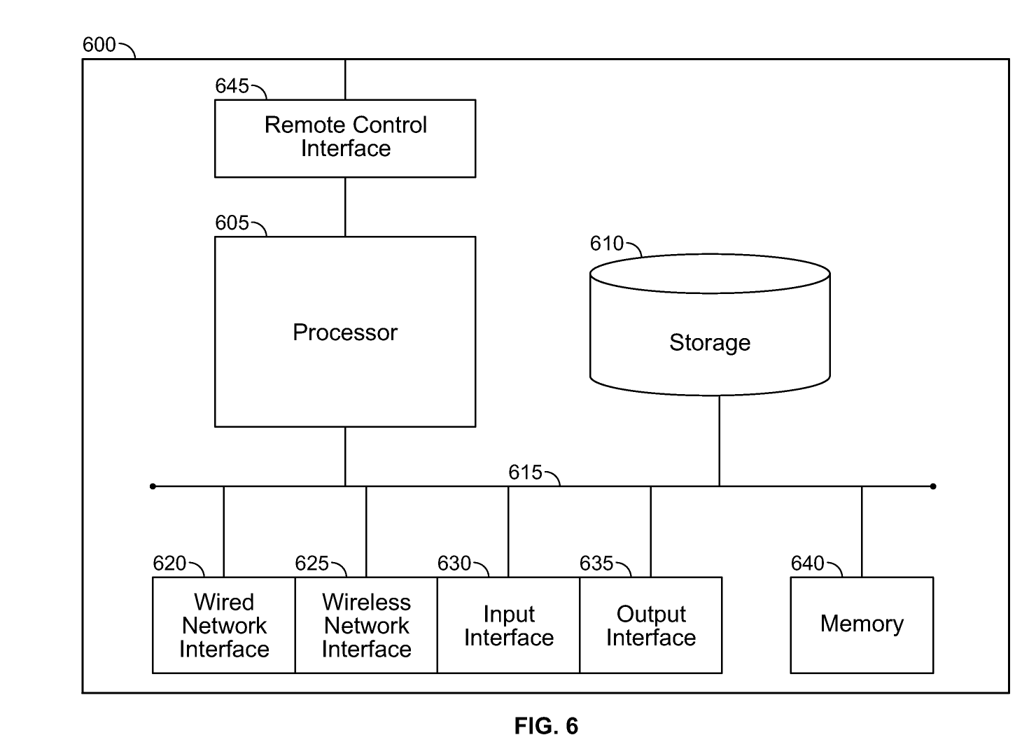

FIG. 6 depicts an exemplary block diagram of an electronic client device 600 that can be used to for eBook applications. The client device 600 includes a processor 605 configured to control the operation of the client device 600. For example, the processor 605 can control communications with one or more media servers to receive eBooks or other media for presentation on the client device 600. A media server can be any general purpose server that provides access to media content. The media can be received through push and/or pull operations, including through downloading and streaming. The processor 605 also can be configured to generate output signals for presentation, such as one or more streams representing media content or an interface for interacting with a user.

The client device 600 also includes a storage device 610 that can be configured to store information including media, configuration data, user preferences, and operating instructions. The storage device 610 can be any type of non-volatile storage, including a hard disk device or a solid-state drive. For example, media received from an external media server can be stored on the storage device 610. The received media thus can be locally accessed and processed. Further, configuration information, such as the resolution of a coupled display device or information identifying an associated media server, can be stored on the storage device 610. Additionally, the storage device 610 can include one or more sets of operating instructions that can be executed by the processor 605 to control operation of the client device 600. In an implementation, the storage device 610 further can be divided into a plurality of partitions, wherein each partition can be utilized to store one or more types of information. Additionally, each partition can have one or more access control provisions.

A communication bus 615 couples the processor 605 to the other components and interfaces included in the client device 600. The communication bus 615 can be configured to permit unidirectional and/or bidirectional communication between the components and interfaces. For example, the processor 605 can retrieve information from and transmit information to the storage device 610 over the communication bus 615. In an implementation, the communication bus 615 can be comprised of a plurality of busses, each of which couples at least one component or interface of the client device 600 with another component or interface.

The client device 600 may also include a plurality of input and output interfaces for communicating with other devices, including media servers and presentation devices. A wired network interface 620 and/or a wireless network interface 625 each can be configured to permit the client device 600 to transmit and receive information over a network, such as a local area network (LAN) or the Internet, thereby enabling either wired and/or wireless connectivity and data transfer. Additionally, an input interface 630 can be configured to receive input from another device through a direct connection, such as a USB, eSATA or an IEEE 1394 connection.

Further, an output interface 635 can be configured to couple the client device 600 to one or more external devices, including a television, a monitor, an audio receiver, and one or more speakers. For example, the output interface 635 can include one or more of an optical audio interface, an RCA connector interface, a component video interface, and a High-Definition Multimedia Interface (HDMI). The output interface 635 also can be configured to provide one signal, such as an audio stream, to a first device and another signal, such as a video stream, to a second device. Further, a non-volatile memory 640, such as a read-only memory (ROM) also can be included in the client device 600. The non-volatile memory 640 can be used to store configuration data, additional instructions, such as one or more operating instructions, and values, such as one or more flags and counters. In an implementation, a random access memory (RAM) also can be included in the client device 600. The RAM can be used to store media content received in the client device 600, such as during playback or while the user has paused playback. Further, media content can be stored in the RAM whether or not the media content is stored on the storage device 610.

Additionally, the client device 600 can include a remote control interface 645 that can be configured to receive commands from one or more remote control devices (not pictured). The remote control interface 645 can receive the commands through wireless signals, such as infrared and radio frequency signals. The received commands can be utilized, such as by the processor 605, to control media playback or to configure the client device 600. In an implementation, the client device 600 can be configured to receive commands from a user through a touch screen interface. The client device 600 also can be configured to receive commands through one or more other input devices, including a keyboard, a keypad, a touch pad, a voice command system, and a mouse.

In implementation, the computing device can be a portable communications device such as a mobile telephone that also contains other functions, such as PDA and/or music player functions. Exemplary embodiments of portable multifunction devices include, without limitation, the iPad®, iPhone® and iPod Touch® devices from Apple, Inc. of Cupertino, Calif. Other portable devices such as laptops or tablet computers with touch-sensitive surfaces (e.g., touch screen displays and/or touch pads) may also be used. In some implementations, the device is not necessarily a portable communications device, but rather can be a desktop computer, for example, with or without a touch-sensitive surface (e.g., a touch screen display and/or a touch pad). The computing device may include a display and a touch-sensitive surface and/or may include one or more other physical user-interface devices, such as a physical keyboard, a mouse and/or a joystick.

The device can be capable of supporting a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent.

Device 600 as represented in FIG. 6 is only an example and that device may have more or fewer components than shown, may combine two or more components, or a may have a different configuration or arrangement of the components. The various components shown in FIG. 6 may be implemented in hardware, software, or a combination of both hardware and software, including one or more signal processing and/or application specific integrated circuits.

What is claimed is:

1. A method performed by an electronic device, the method comprising:
displaying in a reader application executing on the device a first portion of content of an electronic document;
detecting that a user of the reader application has performed a predetermined action that triggers repagination of the electronic document; and
repaginating the electronic document to cause the reader application to display a second portion of content of the electronic document, the second portion including at least some of the first portion of content and at least some newly visible content of the electronic document, wherein the newly visible content appears visually different from the first portion of content that remains visible.

2. The method of claim 1 wherein the detecting comprises determining that the user has selected to change a font size, a font style or a font type of the displayed content.

3. The method of claim 1 wherein the detecting comprises determining that the user has rotated the electronic device from a portrait orientation to a landscape orientation or vice versa.

4. The method of claim 1 further comprising displaying the remaining visible first portion of content in a same manner as prior to repagination and displaying the newly visible content in a different manner.

5. The method of claim 1 further comprising displaying the newly visible content in a same manner as the first portion of content appeared prior to repagination and displaying the remaining visible first portion of content in a different manner after repagination.

6. The method of claim 1 further comprising transitioning appearance of the newly visible content or the remaining visible first content portion, or both, to a state in which the newly visible content and the remaining first content portion appear alike.

7. The method of claim 1 in which repaginating comprises applying a visual transition effect to the new visible content or the remaining first content portion or both.

8. The method of claim 7 in which the visual transition effect comprises a fade.

9. The method of claim 7 in which the visual transition effect comprises a wipe.

10. The method of claim 7 in which the visual transition effect comprises a pop.

11. The method of claim 7 in which the visual transition effect includes one or more of changing color, changing opacity, applying highlighting, changing font size, changing font style, changing font type, or displaying a pointer.

12. The method of claim 7 in which the visual transition effect comprises a translation of a block of old text from a first position on a display screen of the electronic device to a second position on the display screen of the electronic device.

13. The method of claim 7 in which the visual transition effect comprises a float effect in which a block of old text appears to move in a Z-plane from a perspecitive of a user viewing a display screen of the electronic device.

14. The method of claim 1 in which the visual difference between the newly visible content and the remaining visible first content portion is transitory.

15. The method of claim 1 in which the visual difference between the newly visible content and the remaining visible first content portion persists until occurrence of a predetermined event.

16. The method of claim 15 wherein the predetermined event comprises a repagination.

17. The method of claim 15 wherein the predetermined event comprises receiving input from the user.

18. The method of claim 15 wherein the predetermined event comprises passage of a predetermined duration of time.

19. The method of claim 1 wherein only the newly visible content that precedes the first content portion in the electronic document is displayed in a visually different manner.

20. The method of claim 1 wherein newly visible content that follows the first content portion in the electronic document is displayed in a same manner as the remaining visible first content portion.

21. A system comprising:
an electronic device comprising a processor and memory, wherein the memory holds instructions that when executed by the processor perform operations including:
displaying in a reader application executing on the electronic device a first portion of content of an electronic document;
detecting that a user of the reader application has performed a predetermined action that triggers repagination of the electronic document; and
repaginating the electronic document to cause the reader application to display a second portion of content of the electronic document, the second portion including at least some of the first portion of content and at least some newly visible content of the electronic document, wherein the newly visible content appears visually different from the first portion of content that remains visible.

22. The system of claim 21 wherein the detecting comprises determining that the user has selected to change a font size, a font style or a font type of the displayed content.

23. The system of claim 21 wherein the detecting comprises determining that the user has rotated the electronic device from a portrait orientation to a landscape orientation or vice versa.

24. The system of claim 21 further comprising displaying the remaining visible first portion of content in a same manner as prior to repagination and displaying the newly visible content in a different manner.

25. The system of claim 21 further comprising displaying the newly visible content in a same manner as the first portion of content appeared prior to repagination and displaying the remaining visible first portion of content in a different manner after repagination.

26. The system of claim 21 further comprising transitioning appearance of the newly visible content or the remaining visible first content portion, or both, to a state in which the newly visible content and the remaining first content portion appear alike.

27. The system of claim 21 in which repaginating comprises applying a visual transition effect to the new visible content or the remaining first content portion or both.

28. The system of claim 27 in which the visual transition effect comprises one or more of a fade, a wipe, a pop, a translation and a float.

29. The system of claim 27 in which the visual transition effect includes one or more of changing color, changing opacity, applying highlighting, changing font size, changing font style, changing font type, or displaying a pointer.

30. The system of claim 21 in which the visual difference between the newly visible content and the remaining visible first content portion is transitory.

31. The system of claim 21 in which the visual difference between the newly visible content and the remaining visible first content portion persists until occurrence of a predetermined event.

32. The system of claim 31 wherein the predetermined event comprises one or more of a repagination, receiving input from the user, and passage of a predetermined duration of time.

33. An article bearing machine-readable instructions that when executed by a processor perform operations comprising:
displaying in a reader application executing on the electronic device a first portion of content of an electronic document;
detecting that a user of the reader application has performed a predetermined action that triggers repagination of the electronic document; and
repaginating the electronic document to cause the reader application to display a second portion of content of the electronic document, the second portion including at least some of the first portion of content and at least some newly visible content of the electronic document, wherein the newly visible content appears visually different from the first portion of content that remains visible.

34. The article of claim 33 wherein the detecting comprises determining that the user has selected to change a font size, a font style or a font type of the displayed content.

35. The article of claim 33 wherein the detecting comprises determining that the user has rotated the electronic device from a portrait orientation to a landscape orientation or vice versa.

36. The article of claim 33 further comprising displaying the remaining visible first portion of content in a same manner as prior to repagination and displaying the newly visible content in a different manner.

37. The article of claim 33 further comprising displaying the newly visible content in a same manner as the first portion of content appeared prior to repagination and displaying the remaining visible first portion of content in a different manner after repagination.

38. The article of claim 33 further comprising transitioning appearance of the newly visible content or the remaining visible first content portion, or both, to a state in which the newly visible content and the remaining first content portion appear alike.

39. The article of claim 33 in which repaginating comprises applying a visual transition effect to the new visible content or the remaining first content portion or both.

40. The article of claim 39 in which the visual transition effect comprises one or more of a fade, a wipe, a pop, a translation and a float.

41. The article of claim 39 in which the visual transition effect includes one or more of changing color, changing opacity, applying highlighting, changing font size, changing font style, changing font type, or displaying a pointer.

42. The article of claim 33 in which the visual difference between the newly visible content and the remaining visible first content portion is transitory.

43. The article of claim 33 in which the visual difference between the newly visible content and the remaining visible first content portion persists until occurrence of a predetermined event.

44. The article of claim 43 wherein the predetermined event comprises one or more of a repagination, receiving input from the user, and passage of a predetermined duration of time.
